(19) United States
(12) Patent Application Publication
(10) Pub. No.: US 2014/0188589 A1
(43) Pub. Date: Jul. 3, 2014

(54) Price Match Loyalty Program

(71) Applicants: Brad F. Call, Freedom, WY (US); Michael V. Call, Afton, WY (US); Lynn A. Call, Afton, WY (US); John D. Hillam, Kaysville, UT (US); Kerby L. Cate, Layton, UT (US); Ernest R. Harker, Draper, UT (US)

(72) Inventors: Brad F. Call, Freedom, WY (US); Michael V. Call, Afton, WY (US); Lynn A. Call, Afton, WY (US); John D. Hillam, Kaysville, UT (US); Kerby L. Cate, Layton, UT (US); Ernest R. Harker, Draper, UT (US)

(73) Assignee: MAVERIK, INC., Afton, WY (US)

(21) Appl. No.: 13/731,680

(22) Filed: Dec. 31, 2012

(51) Int. Cl. G06Q 30/02

(52) U.S. Cl. CPC G06Q 30/0226
USPC 705/14.33; 705/14.27

(57) ABSTRACT

The present invention extends to methods, systems, and computer program products for providing a price match loyalty program at a retail location. For example, the price match loyalty program can be provided by a fuel station chain as an incentive to its customers by ensuring that the fuel at each station of the chain is at least as inexpensive as at other competitors in the area. The price match loyalty program can be offered for gasoline, diesel, natural gas, biofuels, or any other type of fuel. The price match loyalty program can also be offered for goods other than fuel.

### CROSS-REFERENCE TO RELATED APPLICATIONS

Not Applicable.

### BACKGROUND

Fuel, such as gasoline and diesel, is available in many locations and is sold at highly competitive prices. Because of this, many fuel retailers provide various incentives to encourage customers to purchase fuel at a particular location. For example, some fuel retailers advertise that they provide higher quality fuel, while others provide loyalty or other discounts.

These incentives can be effective in attracting some customers. However, oftentimes, the customer is willing to purchase fuel at any location having the lowest price or a location that is conveniently located. Accordingly, current incentives are only partially effective due to the customer's willingness to purchase fuel at the lowest priced or most convenient location.

### BRIEF SUMMARY

The present invention extends to methods, systems, and computer program products for providing a price match loyalty program at a retail location. For example, the price match loyalty program can be provided by a fuel station chain as an incentive to its customers by ensuring that the fuel at each station of the chain is at least as inexpensive as at other competitors in the area. The price match loyalty program can be offered for gasoline, diesel, natural gas, biofuels, or any other type of fuel. The price match loyalty program can also be offered for goods other than fuel.

In one embodiment, the present invention provides a method for implementing a price match loyalty program. Current prices, that define the price at which an item is being sold by each of a plurality of competitors of a retail location, are received from one or more computer systems. One or more rules are applied to each of the plurality of competitors to identify a set of competitors whose current price is to be used in determining a price match for the item sold at the retail location. From the identified set of competitors, a competitor that offers the item at the lowest price is selected. In response to a request from a customer to purchase the item at the retail location, the price of the item is automatically reduced to the lowest price.

In another embodiment, the present invention provides a method for implementing a price match loyalty program. Current prices, that define the price at which fuel is being sold by each of a plurality of competitors of a retail location, are received from one or more computer systems. One or more rules are applied to each of the plurality of competitors to identify a set of competitors whose current price is to be used in determining a price match for fuel sold at the retail location. From the identified set of competitors, a competitor that offers fuel at the lowest price is selected. A discounted price for fuel sold by the retail location is also determined. The discounted price comprises the price of fuel advertised by the retail location minus a specified discount. In response to a request from a customer to purchase fuel at the retail location, the price of the fuel is automatically reduced to the lower of the lowest price of fuel offered by the competitors and the discounted price.

This summary is provided to introduce a selection of concepts in a simplified form that are further described below in the Detailed Description. This Summary is not intended to identify key features or essential features of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary computer environment in which the present invention can be implemented;

FIGS. 2A and 2B illustrate exemplary configurations of the computer environment of FIG. 1;

FIG. 3 illustrates how competitor prices can be received by a server system;

FIGS. 4 and 5 illustrate exemplary information that can be stored on a server system to implement a price match loyalty program;

FIG. 6 illustrates an example of how the information stored on a server system can be used to identify competitors whose prices will be used to determine a price match;

FIG. 7 provides a diagram of how a customer can benefit from the price match loyalty program of the present invention; and

FIGS. 8 and 9 each illustrate a flowchart of an exemplary method for implementing a price match loyalty program.

### DETAILED DESCRIPTION

The present invention extends to methods, systems, and computer program products for providing a price match loyalty program at a retail location. For example, the price match loyalty program can be provided by a fuel station chain as an incentive to its customers by ensuring that the fuel at each station of the chain is at least as inexpensive as at other competitors in the area. The price match loyalty program can be offered for gasoline, diesel, natural gas, biofuels, or any other type of fuel. The price match loyalty program can also be offered for goods other than fuel.

In one embodiment, the present invention provides a method for implementing a price match loyalty program. Current prices, that define the price at which an item is being sold by each of a plurality of competitors of a retail location, are received from one or more computer systems. One or more rules are applied to each of the plurality of competitors to identify a set of competitors whose current price is to be used in determining a price match for the item sold at the retail location. From the identified set of competitors, a competitor that offers the item at the lowest price is selected. In response to a request from a customer to purchase the item at the retail location, the price of the item is automatically reduced to the lowest price.

In another embodiment, the present invention provides a method for implementing a price match loyalty program. Current prices, that define the price at which fuel is being sold by each of a plurality of competitors of a retail location, are received from one or more computer systems. One or more rules are applied to each of the plurality of competitors to identify a set of competitors whose current price is to be used in determining a price match for fuel sold at the retail location. From the identified set of competitors, a competitor that offers fuel at the lowest price is selected. A discounted price for fuel sold by the retail location is also determined. The discounted price comprises the price of fuel advertised by the retail location minus a specified discount. In response to a request from a customer to purchase fuel at the retail location, the price of the fuel is automatically reduced to the lower of the lowest price of fuel offered by the competitors and the discounted price.

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store program code in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

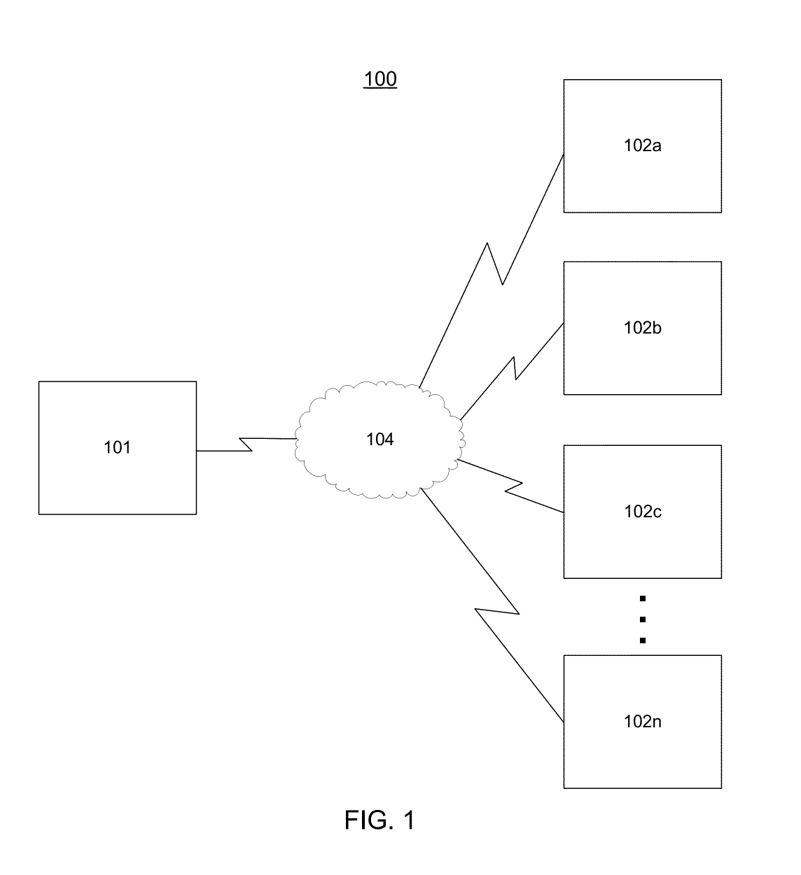

FIG. 1 illustrates an exemplary computer environment 100 in which the present invention can be implemented. Computer environment 100 includes server system 101 and computer systems 102a-102n. Server system 101 can represent any number or type of server computing components. For example, server system 101 can be a single server or a cloud of interconnected computing components.

Computer systems 102a-102n communicate with server system 101 via network 104 to submit and/or receive price information. For example, as further described below, at least some of computer systems 102a-102n can be used to submit competitors' fuel prices to server 101, and at least some of computer systems 102a-102n can be used to receive fuel prices for a particular retail location. Network 104 can represent one or more interconnected networks such as the internet or a local area network.

In some embodiments, at least some of computer systems 102a-102n can be incorporated into a gas pump or located within a retail store and connected with the gas pumps. Also, in some embodiments, one or more of computer systems 102a-102n can communicate with server system 101 but cannot control the fuel price at the gas pump. Accordingly, the specific configuration of computer environment 100 is not essential to the invention, and any computing configuration allowing the price of an item to be adjusted at the point of sale can be used. Further, although this specification uses the example of fuel, the price match loyalty program can be implemented for other goods as well.

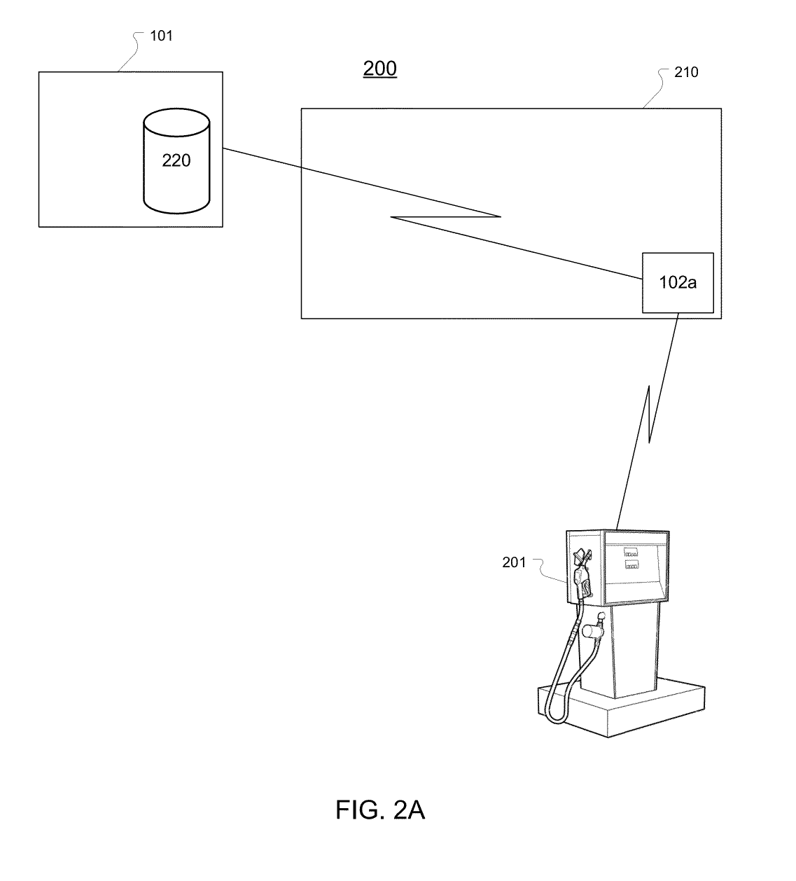

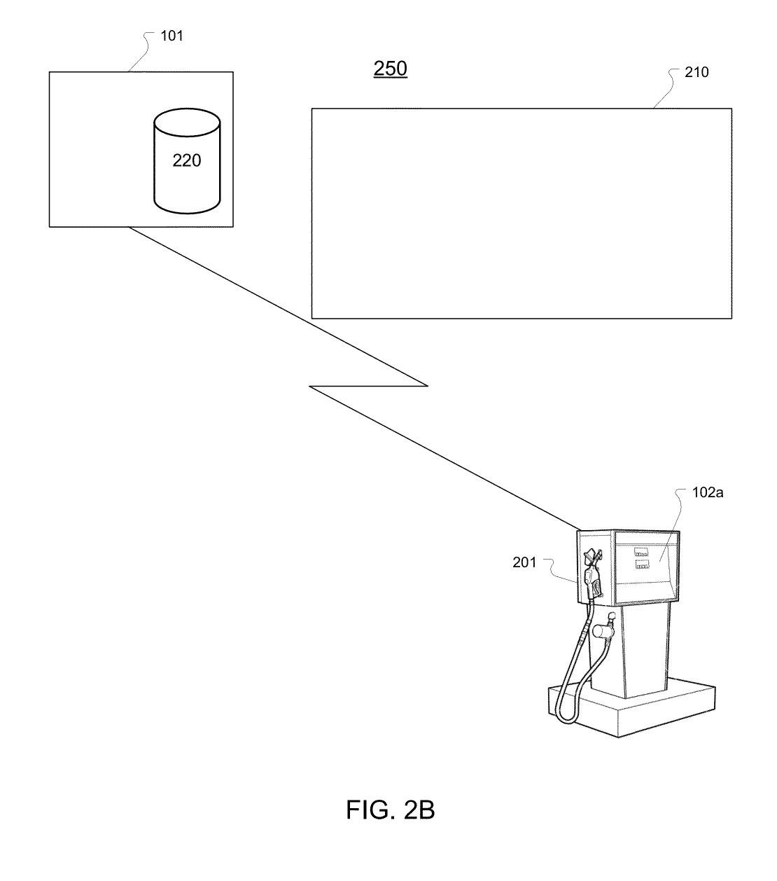

FIG. 2A illustrates an exemplary configuration 200 of computer environment 100 in which a price match loyalty program can be implemented. Configuration 200 includes server system 101, computer system 102a, and gas pump 201. Computer system 102a is shown as being located within a retail location 210. FIG. 2B illustrates an alternative configuration 250 where computer system 102a is incorporated into gas pump 201.

Server system 101 includes a database 220 that stores fuel prices for a number of competitors of retail location 210 and one or more rules for generating a fuel price to be offered to members of a price match loyalty program. Server system 101 can use the fuel prices of the competitors and the one or more rules to generate a fuel price to be offered to customers enrolled in the price match loyalty program of the present invention. Server system 101 can transmit the generated fuel price to computer system 102a which configures gas pump 201 to dispense fuel to the customer at the generated fuel price.

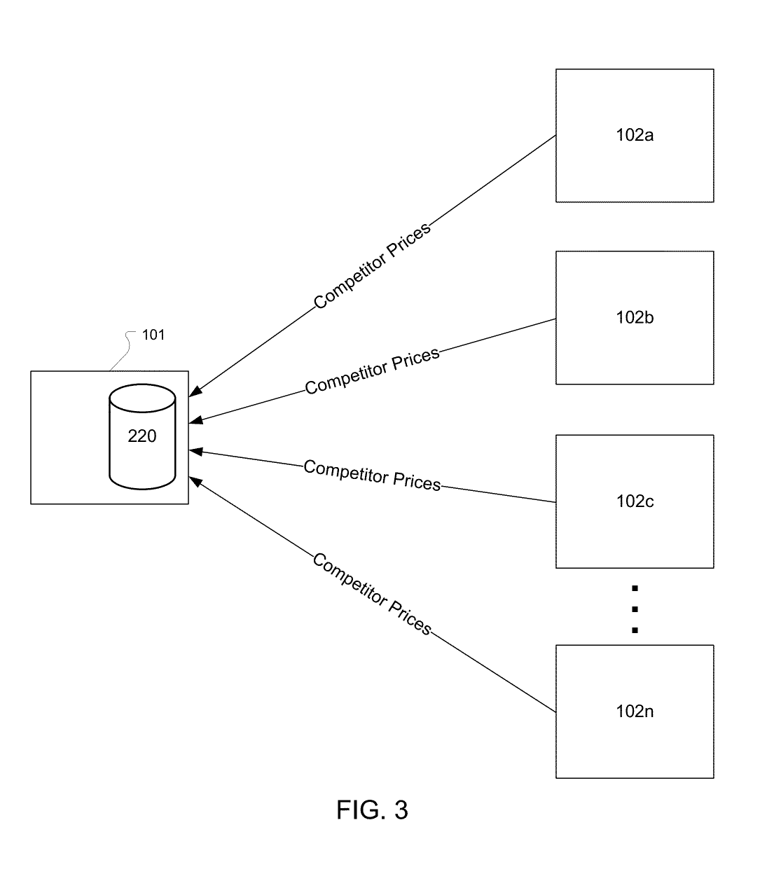

FIG. 3 illustrates how competitor prices can be received by server system 101. As shown, one or more computer systems 102a-102n can be used to transmit fuel prices of competitors to server system 101. Computer systems 102a-102n can be the same computer systems used to set the fuel price for a gas pump or can be another computer system. For example, computer systems 102a-102n can represent an in-store computer, a mobile device carried by an employee or agent of a retail location, or any other computer system capable of communicating with server system 101.

In an exemplary embodiment and referring to FIG. 2A, an employee of retail location 210 can obtain current fuel prices of competitors within a defined area around retail location 210. For example, the employee can drive around to see the posted prices for fuel at one or more competitors, call a competitor to ask what their fuel prices are, access a website or service that provides fuel prices, etc.

Once the current fuel prices of one or more competitors are obtained, the employee can submit the current fuel prices using computer system 102a or another computer system that is located within retail location 210, using a mobile device (e.g. a cell phone), or using another computer system located outside retail location 210. In some embodiments, server system 101 can be configured to automatically obtain fuel prices of competitors such as by accessing a service that provides fuel prices. Competitor fuel prices can be submitted to server system 101 or otherwise obtained by server system 101 at various intervals such as once each morning, in the morning and afternoon each day, on demand, etc.

Regardless of how server system 101 obtains competitor fuel prices, server system 101 stores the current fuel prices in database 220 along with various rules or criteria for processing the current fuel prices to determine fuel prices to offer at one or more retail locations. Once the fuel prices are determined, server system 101 can transmit the fuel prices to the appropriate computer system for controlling the fuel price offered at the pump.

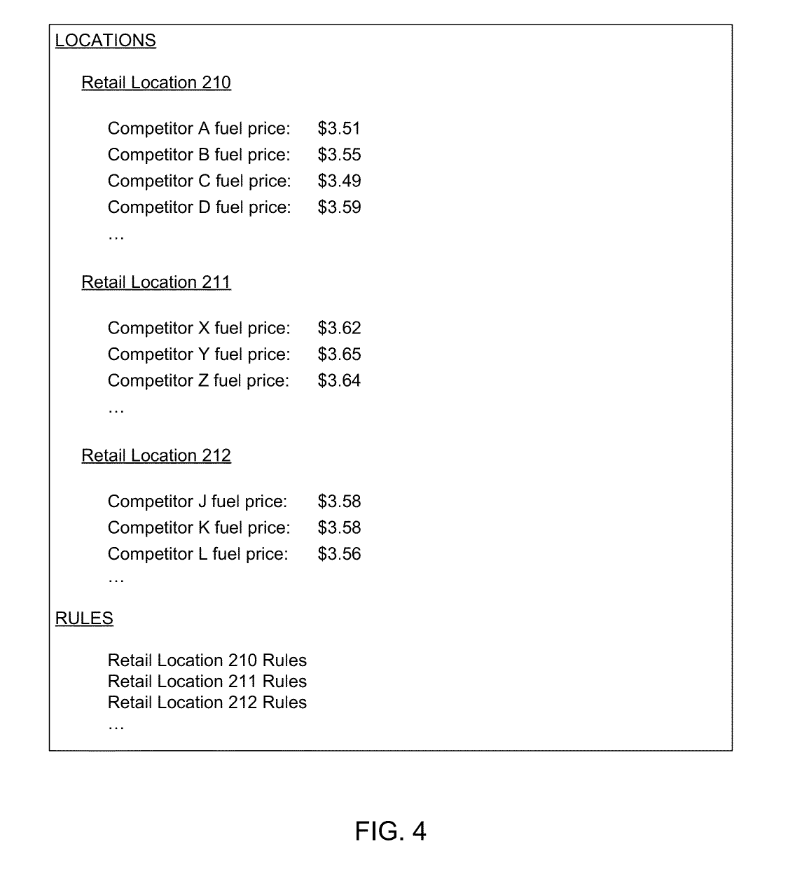

FIG. 4 illustrates a more detailed view of the information that is stored on server system 101. As shown, server system 101 can store competitor fuel prices for many different retail locations. Server system 101 can also store different rules for each retail location. For example, in some embodiments as further described below, rules can define which competitors' fuel prices will be used in determining a fuel price to offer. The determination of a fuel price to offer at any particular retail location can be performed at any time such as once each morning, in the morning and afternoon each day, on demand, etc.

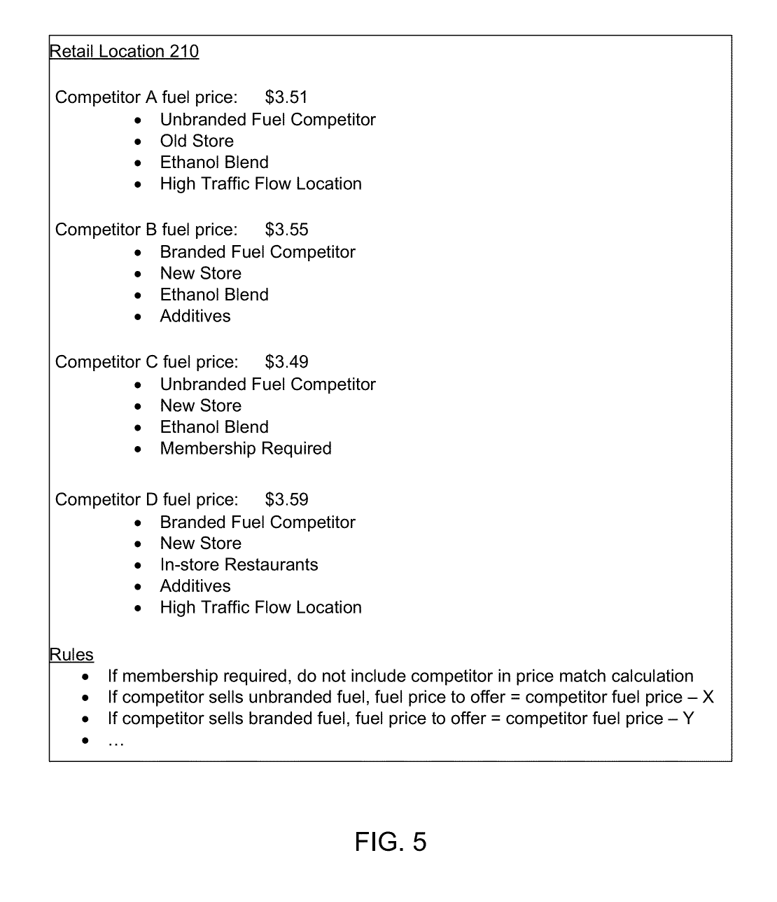

FIG. 5 illustrates a more detailed view of the competitor fuel prices stored for retail location 210 as well as various rules for identifying which competitors' fuel prices to use. As shown, various attributes can be stored with the competitor's fuel price. For example, Competitor A includes attributes of: Unbranded Fuel Competitor, Old Store, Ethanol Blend, and High Traffic Flow Location. Other possible attributes include: Branded Fuel Competitor, New Store, Additives, Membership Required, In-store Restaurants, Distance from Retail Location, and Special Attractions among others. Virtually any attribute can be stored for a particular competitor if it is determined that the attribute may have some effect on a customer's decision where to purchase fuel or another item.

FIG. 5 also shows various rules that can be used to identify which competitors should be included in the calculation of a fuel price to offer and/or what weight should be given to the competitor's fuel price. For example, one rule can specify that a competitor that requires a membership to purchase fuel (e.g. Costco) should not be included in the calculation because of the effect of requiring the customer to purchase a membership. In another example, whether the competitor sells branded or unbranded fuel can be used in determining what weight should be given to a competitor's fuel price in the calculation.

Many other rules can also be used in the calculation. For example, the weight of a competitor's fuel price can be determined based on a combination of the additives in the fuel, whether the fuel is an ethanol blend, and what services are available at the competitor's retail location.

In some embodiments, server system 101 uses the rules and attributes to determine which competitors are to be included in the determination of a fuel price to offer, and then sets the fuel price to be equal to or less than the lowest fuel price of the competitors used in the determination.

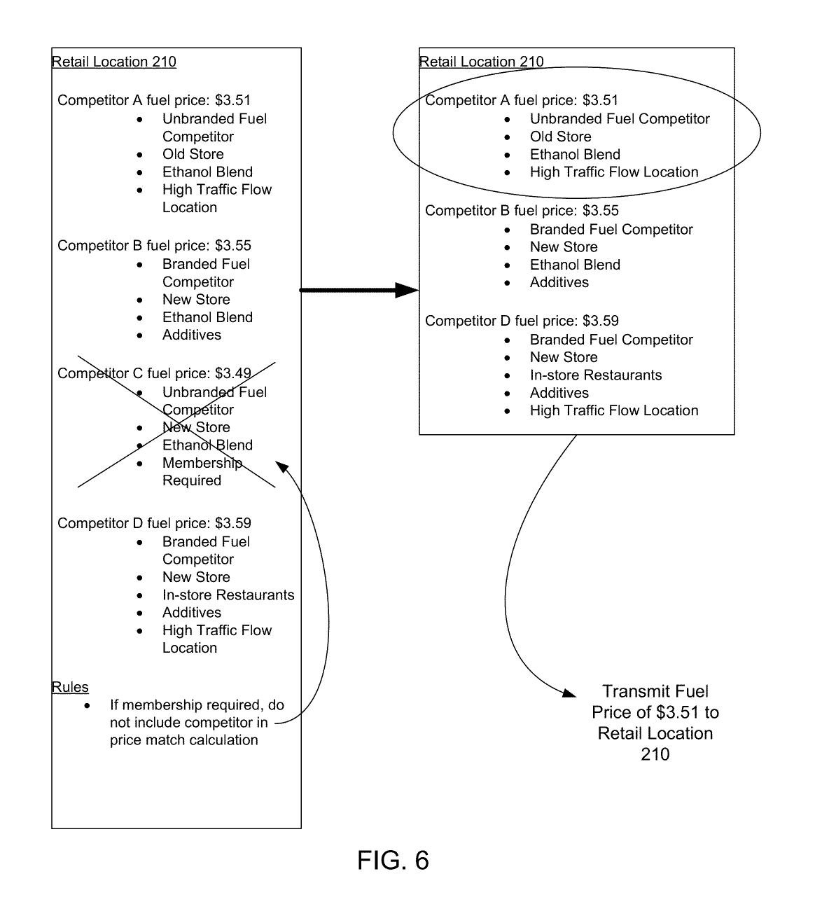

FIG. 6 illustrates an example of how the attributes and rules in FIG. 5 can be used to identify which competitors are to be included in the determination of a fuel price and how the fuel price is determined. As shown, a single rule is used to exclude Competitor C from the determination because Competitor C requires a membership (and therefore, the true fuel price must account for the cost of the membership). Then, the lowest fuel price offered by the remaining competitors is selected which in this case is $3.51 offered by Competitor A. The fuel price of $3.51 is then transmitted to retail location 210 so that customers of retail location 210 are offered fuel for $3.51, the lowest price offered by the competitors. In this way, a customer can be assured that by filling up at retail location 210, he is receiving fuel at the lowest price offered by the competitors without requiring the customer to do anything to identify the lowest price.

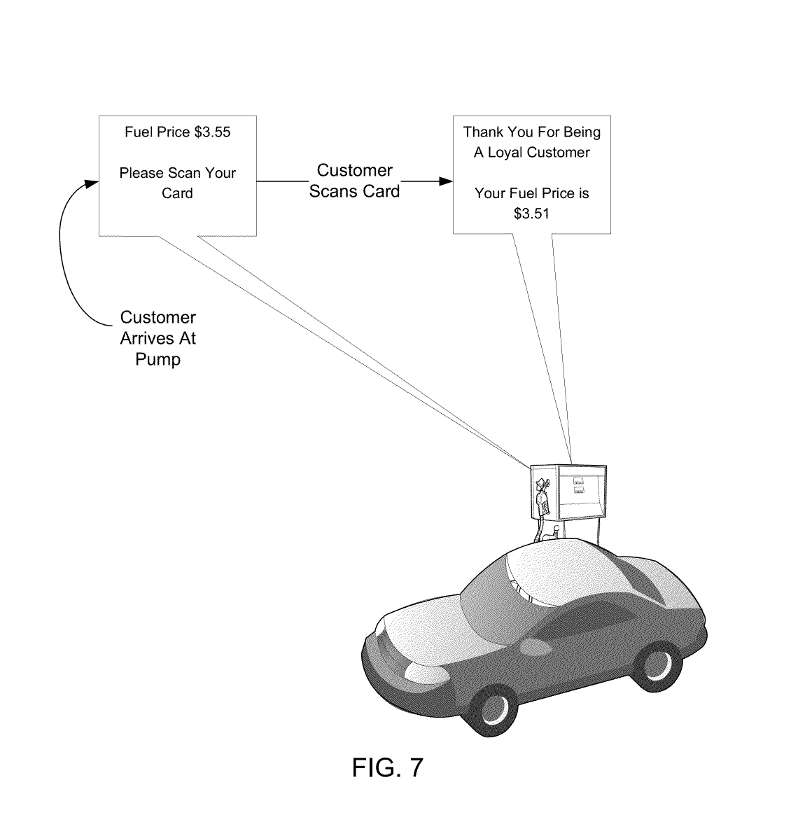

FIG. 7 provides a diagram of how a customer can benefit from the price match loyalty program of the present invention. FIG. 7 shows an example when a customer enrolls in a loyalty program to receive an automatic price match on fuel. As shown, when a customer arrives at the pump, the advertisement fuel price of $3.55 is displayed. When the customer scans his loyalty card, the lowest fuel price of competitors of the retail location is determined (e.g. by accessing a stored fuel price on server system 101 or on another computer system located in the retail location, in the pump, or in another location, by receiving a dynamic calculation from server system 101, etc.).

The determined lowest fuel price of the competitors is compared to the current fuel price offered by the retail location. Because the lowest price of the competitors ($3.51) is less than the current fuel price offered by the retail location ($3.55), the current fuel price is lowered to match the $3.51 price offered by Competitor A.

In some embodiments, an additional determination can be made in setting the fuel price offered to a customer. Specifically, in addition to offering an automatic price match to the lowest competitor fuel price, a retail location can also offer an automatic discount of a specified amount off of the advertised fuel price. For example, using the same example as in FIG. 7, if the loyalty program offers a discount of $0.06 off of the advertised fuel price, this discount can be compared to the lowest competitor price to determine which provides the lowest fuel price. In this example, the $0.06 discount yields a fuel price of $3.49 which is lower than the lowest competitor price of $3.51. Accordingly, the customer would be offered a fuel price of $3.49, the lowest of the two calculated amounts. In this way, the customer can know that he will at least receive the specified discount off of the advertised fuel price, but may also receive a larger discount if the fuel price gets matched to a competitor's lower price.

In this way, the present invention provides an incentive to purchase fuel at a particular retail location because the customer can always know he is getting the best price on fuel. The customer does not need to track fuel prices of any retail locations. By simply identifying himself as a member of a loyalty program, the customer automatically receives the lowest price on fuel.

In some embodiments, the loyalty program can be implemented using a debit card provided by the retail location. For example, a debit card that is issued and managed by the retail location can be scanned by the customer at the pump to obtain the discounts. One benefit of using a debit card issued by the retail location is that there are reduced fees for charging purchases to the card.

Specifically, credit and debit cards issued by credit companies (e.g. Visa, AmEx, Mastercard, etc.) charge a substantial fee when the card is used. This fee is paid by the retailer to the company issuing the card. In the present invention, these fees can be avoided by using a debit card that is managed by the retail location. When a charge is made to the debit card managed by the retail location, the retail location can make an ACH debit directly from the customer's bank account. Although these ACH debits require a fee, the fee is much smaller than the credit card interchange fees or debit fees when using a typical credit or debit card.

Because the retail location does not incur the fee associated with a credit or debit card transaction, the retail location can pass the savings on to the customer in the form of the price match and/or the automatic discount. Accordingly, the price match loyalty program can be implemented using a retailer managed debit card. It is also possible, however, to implement the price match loyalty program without requiring the use of a retailer managed debit card. As such, the present invention is not limited to the use of any particular method of payment.

Although the above description has used fuel as an example, the price match loyalty program of the present invention can be implemented for any other type of good or service. For example, a price match loyalty program can be used to assure customers that they are receiving the lowest price on one or more goods available at a retail store.

Also, a price match loyalty program of the present invention can also beat a lowest price of a competitor. For example, the lowest competitor price can be determined as described above, and the good can be offered to the customer at a price below the lowest competitor (e.g. $0.02 off of the lowest competitor price for fuel). Accordingly, the present invention can be used to determine a price at which to offer a good for sale whether the price matches or beats the lowest competitor price.

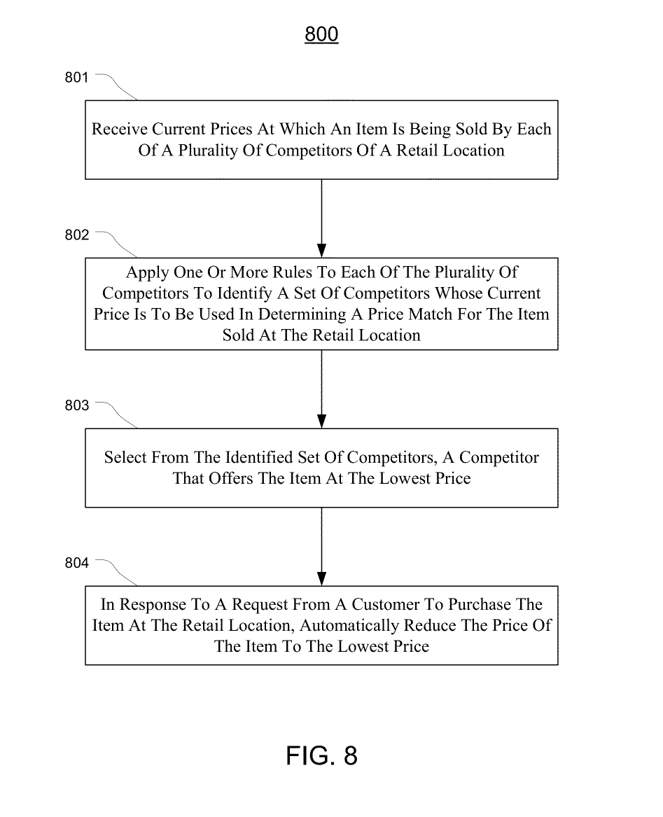

FIG. 8 illustrates a flowchart of an exemplary method 800 for implementing a price match loyalty program. The price match loyalty program can be implemented to offer a customer the lowest price on virtually any type of item.

Method 800 includes an act 801 of receiving, from one or more computer systems, current prices at which an item is being sold by each of a plurality of competitors of a retail location. For example, server system 101 can receive current prices from computer systems 102a-102n.

Method 800 includes an act 802 of applying one or more rules to each of the plurality of competitors to identify a set of competitors whose current price is to be used in determining a price match for the item sold at the retail location. For example, one or more rules that define criteria for identifying competitors whose prices are not to be included in the determination of the price match can be excluded.

Method 800 includes an act 803 of selecting, from the identified set of competitors, a competitor that offers the item at the lowest price. For example, Competitor A's price can be selected as the lowest price offered by the competitors in the set.

Method 800 includes an act 804 of in response to a request from a customer to purchase the item at the retail location, automatically reducing the price of the item to the lowest price. For example, when a customer accesses a fuel pump, the fuel pump can be automatically adjusted to dispense fuel at the lowest price.

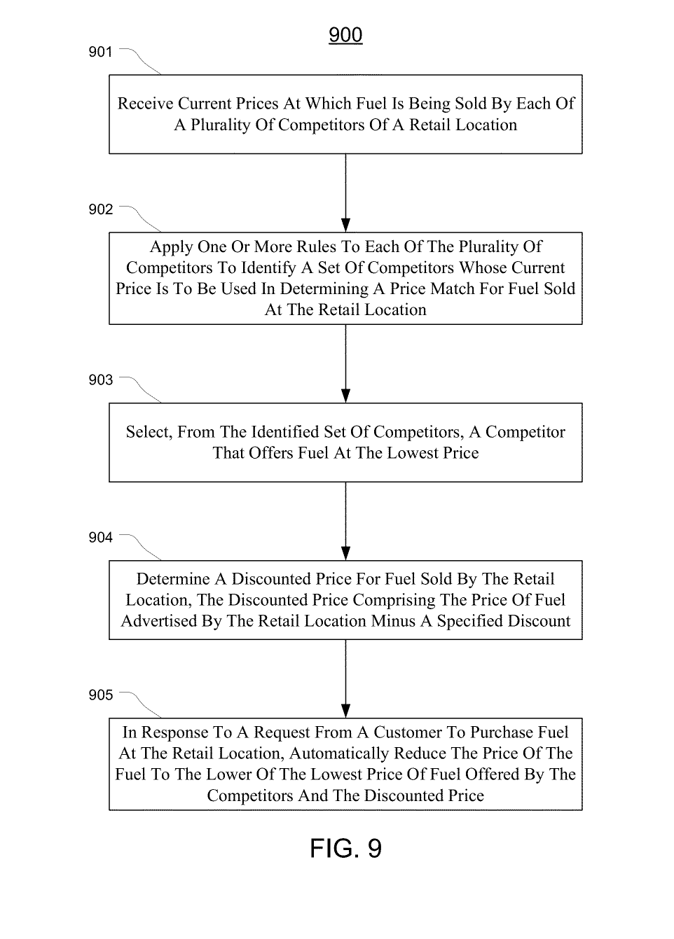

FIG. 9 illustrates a flowchart of an exemplary method 900 for implementing a price match loyalty program. The price match loyalty program can be offered to customers of a retail location that sells fuel.

Method 900 includes an act 901 of receiving, from one or more computer systems, current prices at which an item is being sold by each of a plurality of competitors of a retail location. For example, server system 101 can receive current prices from computer systems 102a-102n.

Method 900 includes an act 902 of applying one or more rules to each of the plurality of competitors to identify a set of competitors whose current price is to be used in determining a price match for the item sold at the retail location. For example, one or more rules that define criteria for identifying competitors whose prices are not to be included in the determination of the price match can be excluded.

Method 900 includes an act 903 of selecting, from the identified set of competitors, a competitor that offers the item at the lowest price. For example, Competitor A's price can be selected as the lowest price offered by the competitors in the set.

Method 900 includes an act 904 of determining a discounted price for fuel sold by the retail location, the discounted price comprising the price of fuel advertised by the retail location minus a specified discount. For example, the discounted price can be determined by subtracted the specified discount from the advertised price of gas at the retail station.

Method 900 includes an act 905 of, in response to a request from a customer to purchase fuel at the retail location, automatically reducing the price of the fuel to the lower of the lowest price of fuel offered by the competitors and the discounted price. For example, when the customer scans a loyalty card at the gas pump, the price of gas at the pump can be automatically adjusted to the lower of the lowest competitor price or the discounted price.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method, performed by a computing system, for implementing a price match loyalty program, the method comprising:
receiving, from one or more computer systems, current prices at which an item is being sold by each of a plurality of competitors of a retail location;
applying one or more rules to each of the plurality of competitors to identify a set of competitors whose current price is to be used in determining a price match for the item sold at the retail location;
selecting, from the identified set of competitors, a competitor that offers the item at the lowest price; and
in response to a request from a customer to purchase the item at the retail location, automatically reducing the price of the item to the lowest price.

2. The method of claim 1, wherein the one or more rules used to identify the set of competitors includes a rule to exclude a competitor from the set if the competitor requires a membership to purchase the item from the competitor.

3. The method of claim 1, wherein the one or more rules used to identify the set of competitors includes a rule to exclude a competitor from the set if the item sold by the competitor is of inferior quality.

4. The method of claim 1, wherein the one or more rules used to identify the set of competitors includes a rule to exclude a competitor from the set if the competitor does not provide one or more services, amenities, or features that the retail location provides.

5. The method of claim 1, wherein the item is fuel.

6. The method of claim 5, wherein the fuel is gasoline or diesel.

7. The method of claim 6, wherein the request from the customer comprises the customer scanning a loyalty card at a fuel pump.

8. The method of claim 1, further comprising:
determining a discounted price for the item, the discounted price comprising a price advertised by the retail location for the item minus a specified amount;
determining that the discounted price is lower than the lowest price offered by the set of competitors; and
automatically reducing the price of the item to the discounted price.

9. The method of claim 1, wherein the request from the customer comprises presenting a loyalty card to pay for the item.

10. The method of claim 9, wherein the loyalty card comprises a debit card managed by the retail location.

11. The method of claim 10, further comprising:
charging a purchase price of the item to the debit card; and
performing an ACH debit to a banking account of the customer to deduct the purchase price from the banking account to cover the charge on the debit card.

12. The method of claim 1, wherein automatically reducing the price of the item to the lowest price comprises transmitting the lowest price to a fuel pump to cause the fuel pump to dispense fuel at the lowest price.

13. The method of claim 1, further comprising:
receiving, from one or more computer systems, an updated current price for one or more of the competitors;
determining that one of the one or more updated current prices is lower than the lowest price;
generating an updated lowest price; and
in response to a request from another customer to purchase the item at the retail location, automatically reducing the price of the item to the updated lowest price.

14. The method of claim 13, wherein the lowest price is selected one day and the updated lowest price is generated either the same day or a subsequent day.

15. A method, performed by a computing system, for implementing a price match loyalty program, the method comprising:
receiving, from one or more computer systems, current prices at which fuel is being sold by each of a plurality of competitors of a retail location;
applying one or more rules to each of the plurality of competitors to identify a set of competitors whose current price is to be used in determining a price match for fuel sold at the retail location;
selecting, from the identified set of competitors, a competitor that offers fuel at the lowest price;
determining a discounted price for fuel sold by the retail location, the discounted price comprising the price of fuel advertised by the retail location minus a specified discount; and
in response to a request from a customer to purchase fuel at the retail location, automatically reducing the price of the fuel to the lower of the lowest price of fuel offered by the competitors and the discounted price.

16. The method of claim 15, wherein the request from the customer comprises scanning a debit card issued by the retail location to the customer, the debit card authorizing the retail location to perform an ACH debit from the customer's bank account to cover the cost of charges to the debit card.

17. A system for implementing a price match loyalty program, the system comprising:
a server system that stores current prices at which competitors of a retail location are offering to sell fuel, the server system further storing one or more rules for identifying a lowest price at which the competitors offer to sell fuel;
a point of sale system located within the retail location, the point of sale system connected to the server system via a network to receive the lowest price; and
a fuel pump that is configured to allow the point of sale system to adjust the price at which fuel is sold to particular customers at the time of purchase;
wherein when the point of sale system receives a notification that a customer enrolled in a price match loyalty program desires to purchase fuel, the point of sale system automatically determines the lowest price at which the competitors offer to sell fuel, compares the lowest price to the current advertised price of fuel at the retail location, and, when the lowest price is lower than the advertised price, automatically configures the fuel pump to reduce the price of fuel from the advertised price to a reduced price, the reduced price comprising either the lowest price or a specified price below the lowest price, such that the customer is enabled to purchase fuel at the reduced price.

18. The system of claim 17, wherein the notification that the customer enrolled in the price match loyalty program desires to purchase fuel is received in response to the customer scanning a loyalty card at the fuel pump.

19. The system of claim 18, wherein the loyalty card comprises a debit card managed by the retail location, the point of sale system being further configured to:
charge the cost of fuel purchased by the customer to the debit card; and
cause an ACH debit to be made from the customer's bank account to cover the charge on the debit card.

20. The system of claim 17, wherein the point of sale system is further configured to determine whether the lowest price is lower than a discounted price, the discounted price comprising the price of fuel advertised by the retail location minus a specified discount offered to the customer, and when the discounted price is lower, automatically configure the fuel pump to reduce the price of fuel from the advertised price to the discounted price such that the customer is enabled to purchase fuel at the discounted price.
